(19) United States
(12) Patent Application Publication
(10) Pub. No.: US 2005/0074739 A1
(43) Pub. Date: Apr. 7, 2005

(54) Makeup set with simulation mirror and accessories

(76) Inventor: Barry Shapiro, Minnetonka, MN (US)

Correspondence Address: Thomas J. Durling;DRINKER BIDDLE & REATH LLP, One Logan Square, 18th & Cherry Streets, Philadelphia, PA, 19103-6996, US

(21) Appl. No.: 10/744,036

(22) Filed: Dec. 23, 2003

Related U.S. Application Data
(60) Provisional application No. 60/484,265, filed on Jun. 30, 2003.

(51) Int. Cl. G09B 25/00

(52) U.S. Cl. 434/377

(57) ABSTRACT

A makeup set is provided comprising a mirror with a reference image disposed thereon that is useful in the marketing of makeup sets. The set allows a user to preview what they would look like after applying the makeup. The set may be packaged in such a way that the mirror may be displayed through a clear window in the packaging. A potential purchaser can simply hold up the package to reflect the user's image and decide whether or not to purchase the makeup set. The set may also be useful in assisting in the application of makeup or the like. A user may also use the image in the mirror to be sure that the user has placed the makeup properly on the user's face to correspond with the image.

### RELATED APPLICATION

This application is related to and claims priority from U.S. Provisional Application Ser. No. 60/484,265, filed Jun. 30, 2003, which is incorporated herein by reference in its entirety.

### FIELD OF THE INVENTION

The present invention relates to a makeup set used in face painting or other application of makeup to the face or body.

### BACKGROUND OF THE INVENTION

Over the years face painting has become a part of mainstream culture, Halloween, for example is a holiday where people of all ages wear masks or paint their faces to disguise themselves. Carnivals, fairs, and sporting events also have face painting stands where people have images painted on their faces.

Makeup sets for face painting are available having multiple colors. The colors may be provided in makeup sticks, in tubes, etc. However, it is often difficult for a consumer to visualize how their face will appear after being painted. Furthermore, if a person desired to paint an image on his or her own face, the person would need to view themselves in a mirror while painting the image on their face. It is also often difficult to approximate the area where the makeup is to be applied.

### SUMMARY OF THE INVENTION

In view of the foregoing, it is an object of the present invention to provide a makeup set comprising a mirror with a reference image that is useful in the marketing of makeup sets. The set allows a user to preview what they would look like after applying the makeup. The set may be packaged in such a way that the mirror may be displayed through a clear window in the packaging. A potential purchaser can simply hold up the package to reflect the user's image and decide whether or not to purchase the makeup set.

It is a further object of the present invention to provide a makeup set for assisting in the application of costume makeup. The mirror has a reflective surface that comprises a reference image disposed thereon. An example of such a reference image is a clown's face. The reference image of a clown may comprise an outline of the face with painted eyebrows, mouth and other facial decorations. A novelty nose may also be depicted as part of the reference image. The reference image may also comprise an area of hair representing a wig. The wig representation may also be an actual sample of the wig material to provide a more realistic preview.

The mirror may be handheld, free standing or affixed to a surface. The image disposed on the mirror serves as a reference for a user to first assess what the user would look like if one's face was painted to correspond with the image in the mirror. A user can align the user's features with the reference image by relative movement between the user and the mirror. A user may also use the image in the mirror to be sure that the user has placed the makeup properly on the user's face, to correspond with the reference image.

The makeup set of the present invention may also comprise makeup/costume accessories for reproducing the image disposed on the mirror on one's face. For example, if the image on the mirror is that of a clown, the corresponding makeup/costume set would include face makeup and other items, that allow a user to apply makeup corresponding to the reference image to make themselves up in the same way. The set may include a novelty nose and wig to complete the clown look.

### BRIEF DESCRIPTION OF THE DRAWINGS

FIG. 1 is a depiction of the makeup set of the present invention.

FIG. 2 is an alternate embodiment of the makeup set of the present invention.

FIG. 3 is a depiction of the makeup set of the present invention in use.

### DETAILED DESCRIPTION OF THE DRAWINGS

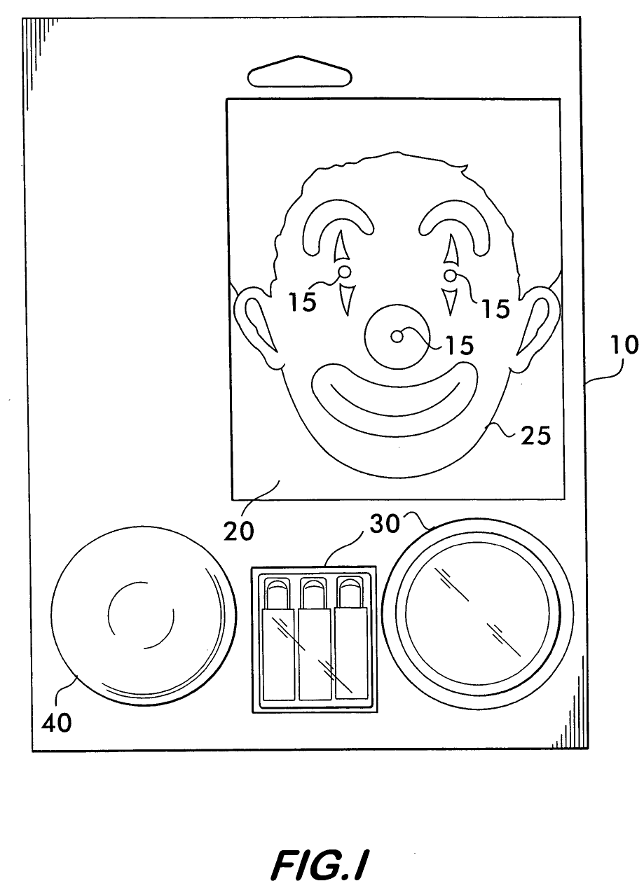

As shown in FIG. 1, there is provided a makeup set 10, comprising a mirror 20, face makeup 30 and novelty nose 40. It should be understood that the term mirror refers to any reflective surface. In this embodiment, mirror 20 has a reference image of a clown 25 disposed thereon. The reflective surface of the mirror 20 may be made of reflective Mylar® (a product of DuPont Teijin Films) or other suitable reflective material disposed on cardstock or other semi-rigid material. The reflective material may be covered by a clear protective layer to prevent scratches. The protective layer may be clear polyvinyl chloride (PVC), polyethylene terephthalate (PET) or other suitable materials. The reference image may be deposed on the mirror by any number of methods. One such deposition method would be to reverse print on the protective layer which in turn is applied to the reflective surface. The protective layer may also be an overlay that is removable from the reflective surface. A user may remove the overlay and place it on another mirror. Alternatively, the reference image 25 may be applied directly to the reflective surface. Other methods of depositing or placing the image on the mirror surface are also possible.

In use, a user selects the set 10 from a display and positions the mirror 20 or positions themselves at an appropriate distance from the user's face in order to align the reference image 25 with the user's own image. The reference image 25 may further comprise alignment guides 15. The guides 15 serve to indicate where a user's eyes and nose are to be aligned for optimal viewing of the reflected image. A user looking at their reflection in the mirror 20 would align the guides 15 so that they would be centered within their eyes and nose. The reflective surface of the mirror 20 will reflect the user's features in frame aligned with the image of the clown 25, for example. The effect is as if the clown image 25 is superimposed on the reflection of the user. The user will see themselves as if they were wearing clown makeup. After selecting, a user may use the mirror in the application of makeup.

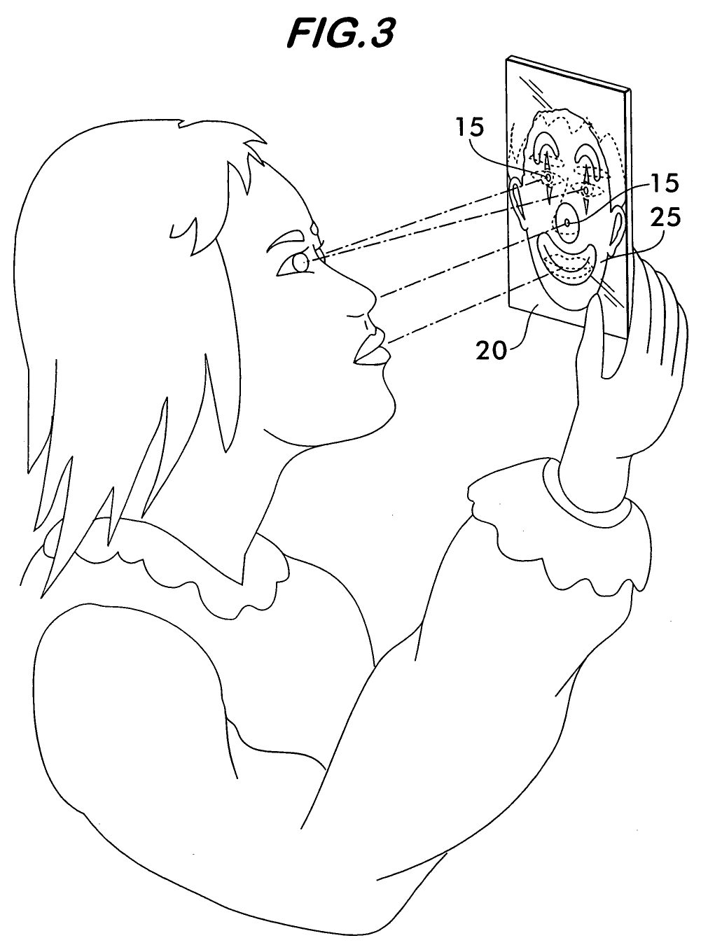

As shown in FIG. 3, a user holds mirror 20 and aligns their reflection with reference image 25 by using guides 15. Once the user's image (shown in broken lines) is in frame with the reference image 25, the user may begin applying makeup 30 to the user's face, using reference image 25 as a guide. The makeup colors 30 may vary depending on the reference image 25. The image 25 thus also serves as a template for applying makeup 30. Reference image 25 may be partially transparent allowing a user to partially see their reflection through the reference image 25. A user may apply the makeup 30 while looking at themselves in mirror 20, to be sure that the makeup applied corresponds to the reference image 25 on mirror 20. In this embodiment, makeup set 10 also comprises a novelty nose 40 to complete the clown face.

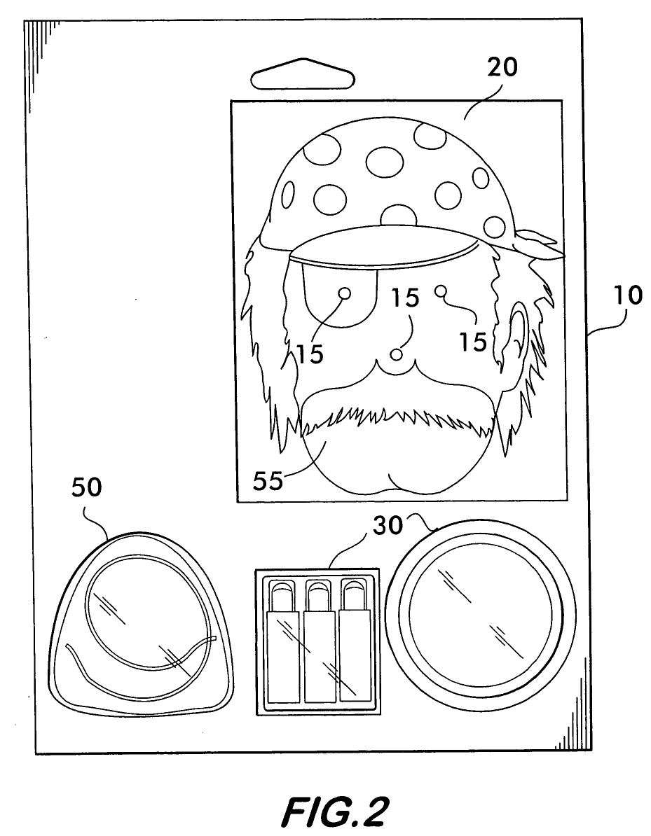

As shown in FIG. 2, there is also provided a makeup set 10, comprising a mirror 20, face makeup 30 and an eye patch 50. In this embodiment, mirror 20 has a reference image of a pirate 55 disposed thereon. In use, as above, a user selects the set 10 from a display and positions the mirror 20 or positions themselves at an appropriate distance from the user's face in order to align the reference image 55 with the user's own image. Reference image 55 may further comprise alignment guides 15 for alignment with a user's eyes and nose. As above, the guides 15 serve to indicate where a user's eyes are to be aligned for optimal viewing of the reference image 55. A user looking at their reflection in the mirror 20 would align the guides 15 so that they would be centered within their eyes and nose. As above, the effect is as if the reference image 55 is superimposed on the reflection of the user. Reference image 55 also serves as a template for applying makeup 30. After selecting, a user may use the mirror in the application of makeup. Once the user's reflection is in frame by using guides 15 the user may begin applying makeup 30 to the user's face. Reference image 55 is slightly transparent allowing a user to partially see through the image 55. A user may apply the makeup 30 while looking at themselves in mirror 20, to be sure that the makeup applied is corresponding to reference image 55 on the mirror 20. In this embodiment, makeup set 10 also comprises an eye patch 50 to complete the pirate face.

The present invention may also be useful in the marketing of makeup sets. The set may be packaged in such a way that the mirror may be displayed through a clear window in the packaging. A potential purchaser can simply hold up the package to reflect the user's image and decide whether or not to purchase the makeup set. The reference image may comprise a sample of a wig that may be packaged with the set. The wig sample may be placed around the hairline of the reference image to give the appearance that the person is wearing a wig. Furthermore since the user can align the user's face in the image frame by using guides 15, the present invention is “one-size-fits-all.”

The images described above, i.e. clown and pirate are examples of images that may be disposed on the mirror. The mirror may have other reference images such as cartoon characters, movie monsters, historical figures, etc. Alternatively, the mirror may also comprise reference images in the form of sports team logos, or other indicia to facilitate in the painting of one's face. Furthermore the set may comprise non-makeup items such as hats, masks and appliances such as scars, warts, etc. These items may be previewed in the same manner as described above.

1. A makeup kit for previewing the semblance of makeup to a user's person, the kit comprising:
a mirror having a reflective surface thereon;
a reference image disposed on the surface of the mirror, the reference image able to be aligned with a user's body part for reference purposes; and
at least one makeup color for reproducing a portion of the reference image on a user's body part while viewing the reflection in the mirror along with the reference image.

2. The makeup kit as claimed in claim 1, wherein the kit is packaged in a see-through material.

3. The makeup kit as claimed in claim 1, wherein the reference image further comprises at least one alignment guide.

4. The makeup kit as claimed in claim 1, wherein the reference image is a depiction of a clown's face.

5. The makeup kit as claimed in claim 1, wherein the reference image is a depiction of a pirate's face.

6. The makeup kit as claimed in claim 1, wherein the reference image is a logo.

7. The makeup kit as claimed in claim 1, wherein the kit further comprises a costume article.

8. The makeup kit as claimed in claim 7, wherein the costume article is a wig.

9. The makeup kit as claimed in claim 7, wherein the costume article is an eye patch.

10. The makeup kit as claimed in claim 7, wherein the costume article is a hat.

11. A mirror, for previewing the semblance of makeup to a user's person, the mirror having a reflective surface thereon and comprising:
a reference image disposed on the surface of the mirror, the reference image able to be aligned with a user's body part for reference purposes; and
at least one alignment guide for aligning a user's body part with the reference image, the alignment guide disposed within the reference image.

12. The mirror as claimed in claim 11, wherein the mirror is packaged in a see-through material.

13. The mirror as claimed in claim 12, wherein the packaged mirror further comprises at least one makeup color for reproducing a portion of the reference image.

14. The makeup kit as claimed in claim 11, wherein the kit further comprises a costume article.

15. The makeup kit as claimed in claim 14, wherein the costume article is a wig.

16. The makeup kit as claimed in claim 14, wherein the costume article is an eye patch.

17. The makeup kit as claimed in claim 14, wherein the costume article is a hat.

18. A makeup kit for previewing the semblance of makeup to a user's person, the kit comprising:
a see-through packaging material;
a mirror having a reflective surface thereon;
a reference image formed on the surface of the mirror, the reference image able to be aligned with a user's body part for reference purposes, the reference image further comprises at least one alignment guide; and
at least one makeup color for reproducing a portion of the reference image on a user's body part while viewing the reflection in the mirror along with the reference image.

19. The makeup kit as claimed in claim 18, wherein the kit further comprises a costume article.

20. The makeup kit as claimed in claim 18, wherein the costume article is a wig.

21. The makeup kit as claimed in claim 18, wherein the costume article is an eye patch.

22. The makeup kit as claimed in claim 18, wherein the costume article is a hat.
